(19) United States
(12) Patent Application Publication
(10) Pub. No.: US 2019/0362164 A1
(43) Pub. Date: Nov. 28, 2019

(54) IMAGE RECOGNITION DEVICE, IMAGE RECOGNITION METHOD, AND PARKING ASSIST SYSTEM

(71) Applicants: DENSO TEN Limited, Kobe-shi (JP); TOYOTA JIDOSHA KABUSHIKI KAISHA, Toyota-shi (JP)

(72) Inventors: Tetsuo YAMAMOTO, Kobe-shi (JP); Takuya ITO, Toyota-shi (JP)

(73) Assignees: DENSO TEN Limited, Kobe-shi (JP); TOYOTA JIDOSHA KABUSHIKI KAISHA, Toyota-shi (JP)

(21) Appl. No.: 16/270,038

(22) Filed: Feb. 7, 2019

(30) Foreign Application Priority Data
May 28, 2018 (JP) 2018-101443

(51) Int. Cl. G06K 9/00; H04N 5/247; G06K 9/03; G06T 7/90; G06T 7/70; G06T 7/60

(52) U.S. Cl. CPC G06K 9/00812; H04N 5/247; G06K 9/03; B62D 15/0285; G06T 7/70; G06T 7/60; G06T 2207/30264; G06T 7/90

(57) ABSTRACT

An image recognition device has a searcher, a determiner, and recognizer. The searcher searches for a demarcation line indicating a parking bay based on a first taken image obtained by a first camera taking an image around a vehicle. The determiner determines a parking position at which to park based on the result of searching by the searcher. The recognizer recognizes, after determination by the determiner, the demarcation line based on a second taken image obtained by a second camera taking an image around the vehicle. The recognizer corrects the recognition of the demarcation line in the second taken image based on the result of recognition, obtained in the searcher, of the first taken image.

This nonprovisional application claims priority under 35 U.S.C. § 119(a) on Patent Application No. 2018-101443 filed in Japan on May 28, 2018, the entire contents of which are hereby incorporated by reference.

### BACKGROUND OF THE INVENTION

### 1. Field of the Invention

The present invention relates to an image recognition technology for recognizing demarcation lines.

### 2. Description of Related Art

Recent years have seen development of a technology whereby demarcation lines (parking bay lines) such as white lines are recognized from a camera image and, based on the recognized demarcation lines, a parking frame is constructed (see, for example, Japanese Patent Application published as No. 2010-195224).

With the parking frame construction technology disclosed in JP-A-2010-195224, demarcation lines are recognized only from a taken image obtained by a rear camera that takes an image rearward of a vehicle and, based on the so recognized demarcation lines, a parking frame is constructed. In other words, with the parking frame construction technology disclosed in JP-A-2010-195224, demarcation lines are recognized only from a taken image obtained by a rear camera that takes an image rearward of a vehicle and, based on the so recognized demarcation lines, a predetermined parking position is determined.

As a rear camera, a wide-angle camera is generally used. A taken image obtained by a wide-angle camera has, in an edge part, larger distortion and thus lower resolution than in a central part.

Accordingly, when a reference vehicle V1 passes in front of demarcation lines LN as shown in FIG. 8, the demarcation lines LN, which are located sideways of the reference vehicle V1, appear in an edge part of the taken image obtained by the rear camera, and are thus recognized with low accuracy. As a result, a parking frame may be constructed with a deviation from an appropriate position.

### SUMMARY OF THE INVENTION

An object of the present invention is to provide an image recognition technology with which erroneous recognition of demarcation lines is less likely.

According to one aspect of the present invention, an image recognition device includes: a searcher configured to search for a demarcation line indicating a parking bay based on a first taken image obtained by a first camera taking an image around a vehicle; a determiner configured to determine a parking position at which to park based on the result of searching by the searcher; and a recognizer configured to recognize, after determination by the determiner, the demarcation line based on a second taken image obtained by a second camera taking an image around the vehicle. Here, the recognizer corrects the recognition of the demarcation line in the second taken image based on the result of recognition, obtained in the searcher, of the first taken image.

According to another aspect of the present invention, an image recognition method involves: a searching step of searching for a demarcation line indicating a parking bay based on a first taken image obtained by a first camera taking an image around a vehicle; a determining step of determining a parking position at which to park based on the result of searching in the searching step; and a recognizing step of recognizing, after determination in the determining step, the demarcation line based on a second taken image obtained by a second camera taking an image around the vehicle. Here, in the recognizing step, the recognition of the demarcation line in the second taken image is corrected based on the result of recognition, obtained in the searching step, of the first taken image.

According to yet another aspect of the present invention, a parking assist system includes: an image recognition device configured as described above; and a parking control device configured to calculate the amount of control for the vehicle based on the result of recognition by the image recognition device.

### BRIEF DESCRIPTION OF THE DRAWINGS

FIG. 1 is a diagram showing one configuration example of a parking assist system;

FIG. 2A is a diagram showing a positon of a reference vehicle in a parking facility;

FIG. 2B is a diagram showing a positon of a reference vehicle in a parking facility;

FIG. 2C is a diagram showing a positon of a reference vehicle in a parking facility;

FIG. 2D is a diagram showing a positon of a reference vehicle in a parking facility;

FIG. 3 is a flow chart showing an example of the operation of an image processing ECU and a parking control ECU;

FIG. 4 is a flow chart showing an algorithm for calculating a target parking position;

FIG. 5 is a top view showing a relationship between end point coordinates and candidate coordinates of a target parking position;

FIG. 6A is a diagram showing demarcation lines in an I shape;

FIG. 6B is a diagram showing demarcation lines in a U shape;

FIG. 6C is a diagram showing demarcation lines in a square-open-at-one side shape;

FIG. 7 is a diagram showing demarcation lines in a square-open-at-one side shape; and

FIG. 8 is a diagram showing a positon of a reference vehicle in a parking facility.

### DETAILED DESCRIPTION OF PREFERRED EMBODIMENTS

Hereinafter, illustrative embodiments of the present invention will be described in detail with reference to the accompanying drawings. The different directions mentioned in the following description are defined as follows: The direction which runs along the vehicle's straight traveling direction and which points from the driver's seat to the steering wheel is referred to as the “front” direction (frontward). The direction which runs along the vehicle's straight traveling direction and which points from the steering wheel to the driver's seat is referred to as the “rear” direction (rearward). The direction which runs perpendicularly to both the vehicle's straight traveling direction and the vertical line and which points from the right side to the left side of the driver facing frontward is referred to as the “left” direction (leftward). The direction which runs perpendicularly to both the vehicle's straight traveling direction and the vertical line and which points from the left side to the right side of the driver facing frontward is referred to as the “right” direction (rightward). A vehicle furnished with a parking assist system is referred to as a “reference vehicle”.

1. Configuration of a Parking Assist System

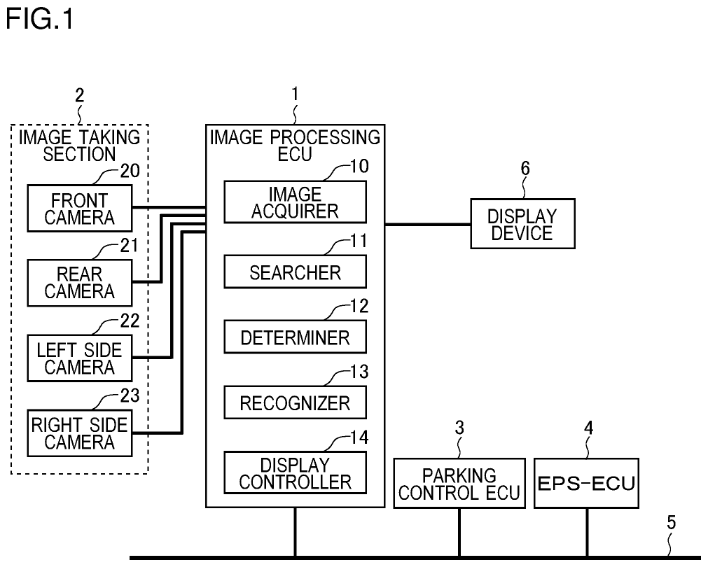

FIG. 1 is a diagram showing one configuration example of a parking assist system. The parking assist system shown in FIG. 1 includes an image processing ECU (electronic control unit) 1, an image taking section 2, a parking control ECU 3, an EPS (electronic power steering)-ECU 4, an on-board network 5, and a display device 6.

The image processing ECU 1 is connected to the image taking section 2 and to the display device 6, and is connected also to the parking control ECU 3 and to the EPS-ECU 4 via the on-board network 5 such as a CAN (controller area network).

The image taking section 2 includes four cameras 20 to 23. The camera 20 is provided at the front end of the reference vehicle. Accordingly, the camera 20 is referred to also as the front camera 20. The camera 21 is provided at the rear end of the reference vehicle. Accordingly, the camera 21 is referred to also as the rear camera 21. As seen in a top view, the optical axes of the front and back cameras 20 and 21 run along the front-rear direction of the reference vehicle. The front camera 20 takes an image frontward of the reference vehicle. The rear camera 21 takes an image rearward of the reference vehicle. The installation positions of the front and rear cameras 20 and 21 are preferably at the center in the left-right direction of the reference vehicle, but can instead be positions slightly deviated from the center in the left-right direction.

The camera 22 is provided on a left-side door mirror of the reference vehicle. Accordingly, the camera 22 is referred to also as the left side camera 22. In a case where the reference vehicle is what is called a door-mirrorless vehicle, the left side camera 22 is fitted somewhere around the pivot shaft (hinge) of the left side door with no door mirror in between. As seen in a top view, the optical axis of the left side camera 22 runs along the left-right direction of the reference vehicle. The left side camera 22 takes an image leftward of the reference vehicle. The camera 23 is provided on a right-side door mirror of the reference vehicle. Accordingly, the camera 23 is referred to also as the right side camera 23. In a case where the reference vehicle is what is called a door-mirrorless vehicle, the right side camera 23 is fitted somewhere around the pivot shaft (hinge) of the right side door with no door mirror in between. As seen in a top view, the optical axis of the right side camera 23 runs along the left-right direction of the reference vehicle. The right side camera 23 takes an image rightward of the reference vehicle.

The image processing ECU 1 includes an image acquirer 10, a searcher 11, a determiner 12, a recognizer 13, and a display controller 14. The image processing ECU 1 acts both as an image recognition device that recognizes an image and as a display control device that controls display on the display device 6.

The image processing ECU 1 can be composed of, for example, a controller and a storage. The controller is a computer including a CPU (central processing unit), a RAM (random-access memory), and a ROM (read-only memory). The storage stores, on a non-volatile basis, computer programs and data necessary for the image processing ECU 1 to operate to function as the image acquirer 10, the searcher 11, the determiner 12, the recognizer 13, and the display controller 14. Usable as the storage is, for example, an EEPROM or a flash memory.

The image acquirer 10 acquires an analog or digital taken image from each of the cameras 20 to 23 at a predetermined period (for example, at a period of 1/30 seconds) in a temporally continuous fashion. In a case where the acquired temporally continuous taken image (acquired image) is analog, the image acquirer 10 converts the analog taken image into a digital taken image (through analog-to-digital conversion).

Based on the taken images of the left and right side cameras 22 and 23 that are output from the image acquirer 10, the searcher 11 searches for demarcation lines indicating parking bays. The searcher 11 starts to search for demarcation lines indicating parking bays when, for example, the traveling speed of the reference vehicle falls below a predetermined speed. In this embodiment, the searcher 11 recognizes, from the taken images of the left and right side cameras 22 and 23, demarcation lines indicating parking bays through image processing such as edge extraction at a period of, for example, 100 ms, and recognizes parking frames based on the recognized demarcation lines. Demarcation lines are drawn, in the form of white or yellow lines, on the paved surface of a parking facility. Based on the recognized parking frames, the determiner 12 determines a parking position at which to park. In this embodiment, the determiner 12 takes the vacant parking bay that is closest to the reference vehicle at the moment it stops as the parking position at which to park.

After the determination by the determiner 12, the recognizer 13 recognizes, from the taken image of the rear camera 21, the demarcation lines of the parking position at which to park through image processing such as edge extraction at a period of, for example, 100 ms, and recognizes parking frames based on the recognized demarcation lines.

The recognizer 13 calculates a target parking position corresponding to the parking position determined by the determiner 12. The recognizer 13 then transmits the target parking position to the parking control ECU 3, and then receives a target parking position inferred by the parking control ECU 3.

Based on the result of recognition, obtained in the searcher 11, of the taken images of the left and right side cameras 22 and 23, the recognizer 13 corrects the taken image of the rear camera 21. Some specific examples of this correction will be discussed later.

The display controller 14 controls display on the display device 6. For example, the display controller 14 generates a display image having an indicator indicating the target parking position overlaid on the taken image output from the image acquirer 10.

The parking control ECU 3 infers, based on the target parking position received from the image processing ECU 1 and the output of an unillustrated clearance sonar sensor, a parkable target parking position. The parking control ECU 3 may instead first infer the amount of movement of the reference vehicle based on information on the reference vehicle's steering angle, traveling speed, shift position, and the like acquired via the on-board network 5 and then infer, based on the inferred amount of movement of the reference vehicle and the target parking position received from the image processing ECU 1, a target parking position corresponding to the inferred amount of movement of the reference vehicle. The parking control ECU 3 transmits the inferred target parking position to the image processing ECU 1. Furthermore, the parking control ECU 3 calculates, based on the output of the unillustrated clearance sonar sensor and the target parking position, an amount of steering, and transmits information on the amount of steering to the EPS-ECU 4. Any target parking position that cannot be attained by any steering control is deleted during the estimation of a target parking position.

Based on the information on the amount of steering received from the parking control ECU 3, the EPS-ECU 4 performs automatic steering during parking operation of the reference vehicle. On the other hand, accelerating and braking are performed by the driver.

2. Outline of the Operation of the Parking Assist System

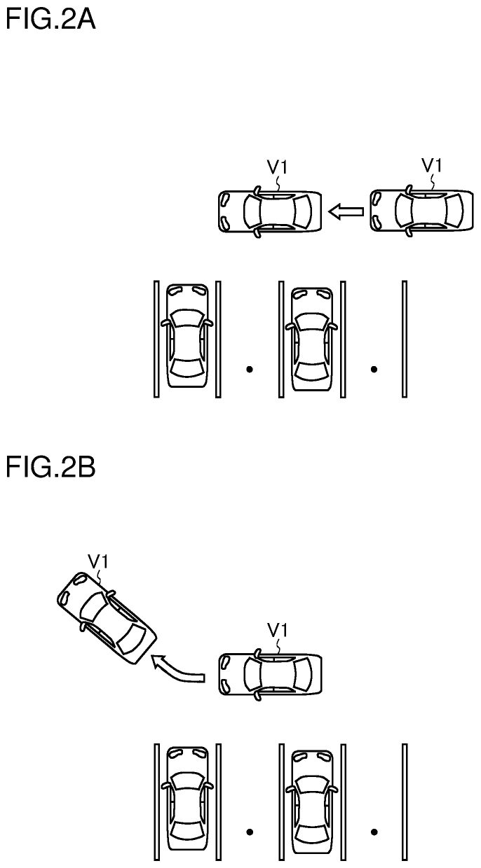

An outline of the operation of the parking assist system will now be described with reference to a parking sequence. FIGS. 2A to 2D are diagrams each showing a position of the reference vehicle in a parking facility. The parking sequence proceeds from FIG. 2A to FIG. 2B, to FIG. 2C to FIG. 2D.

During a period (hereinafter referred to as period A) in which, as shown in FIG. 2A, the reference vehicle V1 is traveling straight at a speed equal to or lower than a predetermined speed, the searcher 11 recognizes the demarcation lines of a vacant parking bay based on the taken images of the left and right side cameras 22 and 23. Based on the result of recognition of the demarcation lines by the searcher 11, the recognizer 13 calculates a target parking position in the vacant parking bay. In FIG. 2A, each black spot indicates the target parking position in a vacant parking bay.

During a period (hereinafter referred to as period B) in which, as shown in FIG. 2B, the reference vehicle V1 is traveling forward while turning, the searcher 11 recognizes the demarcation lines of a vacant parking bay based on the taken images of the side camera on the outside of the turn (in FIG. 2B, the left side camera 22) and the rear camera 21. Based on the result of recognition of the demarcation lines by the searcher 11, the recognizer 13 calculates a target parking position in the vacant parking bay. In FIG. 2B, each black spot indicates the target parking positions in a vacant parking bay.

During a period (hereinafter referred to as period C) in which, as shown in FIG. 2C, the reference vehicle V1 is traveling backward outside the parking frame FM of the parking bay in which to halt or park, the recognizer 13 recognizes the demarcation lines of the parking bay in which to park based on the taken image of the rear camera 21. Here, the recognizer 13 uses not the whole of the taken image of the rear camera 21 but only a region around end points of demarcation lines recognized last time or before. Based on the result of recognition of the demarcation lines, the recognizer 13 calculates a target parking position in the parking bay in which to park. In FIG. 2C, a black spot indicates the target parking position in the parking bay in which to park.

During a period (hereinafter referred to as period D) in which, as shown in FIG. 2D, the reference vehicle V1 is traveling backward with at least part of it having entered the parking frame FM of the parking bay in which to park, the recognizer 13 recognizes the demarcation lines of the parking bay in which to park based on the taken images of the left and right side cameras 22 and 23. Here, the recognizer 13 uses not the whole of the taken images of the left and right side cameras 22 and 23 but only a region around end points of demarcation lines recognized last time or before. Based on the result of recognition of the demarcation lines, the recognizer 13 calculates a target parking position in the parking bay in which to park. In FIG. 2D, a black spot indicates the target parking position in the parking bay in which to park. During period D, demarcation lines are recognized without the use of the taken image of the rear camera 21; thus, even if a demarcation line is located in an edge part of the taken image of the rear camera 21, it is possible to suppress deviation of a parking frame corresponding to a vacant parking bay, and of the target parking position, from an appropriate position.

Based on the result of recognition of the taken images of the left and right side cameras 22 and 23 obtained during period A as well as the result of recognition of the taken image of the side camera on the outside of the turn obtained during period B, the searcher 11 corrects the recognition of the taken image of the rear camera 21 obtained during period B. This improves the accuracy with which demarcation lines are recognized based on the taken image of the rear camera 21 obtained during period B. It is thus possible to suppress deviation of a parking frame corresponding to a vacant parking bay, and of the target parking position, from an appropriate position.

Based on the result of recognition of the taken images of the left and right side cameras 22 and 23 obtained during period A as well as the result of recognition of the taken image of the side camera on the outside of the turn obtained during period B, the recognizer 13 corrects the recognition of the taken image of the rear camera 21 obtained during period C. This improves the accuracy with which demarcation lines are recognized based on the taken image of the rear camera 21 obtained during period C. It is thus possible to suppress deviation of a parking frame corresponding to a parking bay in which to park, and of the target parking position, from an appropriate position.

3. Operation of the Image Processing ECU and the Parking Control ECU

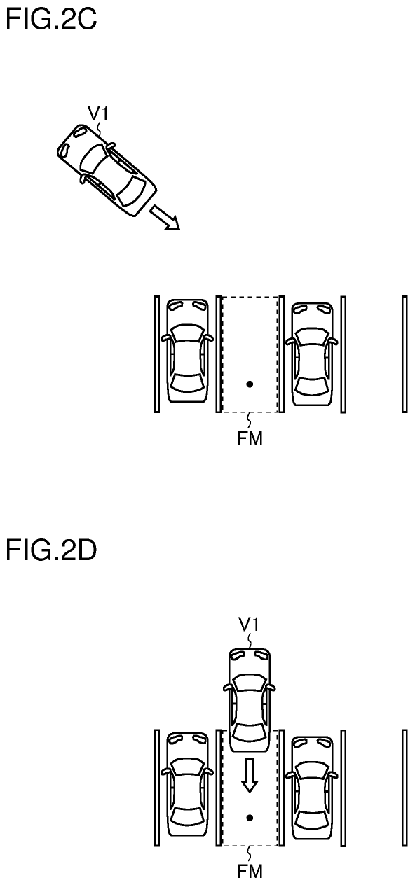

Next, the operation of the image processing ECU 1 and the parking control ECU 3 will be described. FIG. 3 is a flow chart showing an example of the operation of the image processing ECU 1 and the parking control ECU 3. The principal agent of operation for demarcation line recognition and parking frame recognition is the searcher 11 or the recognizer 13 in the image processing ECU 1.

In the flow of operation shown in FIG. 3, first, the image processing ECU 1 tries to detect demarcation lines (step S1).

Having detected demarcation lines, the image processing ECU 1 converts the coordinate system of the camera images into a coordinate system (world coordinate system) with its origin located at a particular point on the vehicle (step S2). In this embodiment, the particular point on the vehicle is defined to be a point that is apart rearward from the front end of the vehicle by an effective length (the length calculated by subtracting the rear overhang from the vehicle's total length) and that is at the middle in the left-right direction of the vehicle. In the world coordinate system, the front-rear direction of the vehicle is the Z-axis direction (the rear direction being the positive Z-axis direction), and the left-right direction of the vehicle is the X-axis direction (the left direction being the positive X-axis direction).

Subsequently to step S2, at step S3, the image processing ECU 1 recognizes a parking frame based on the camera images.

Next, based on the recognized parking frame, the determiner 12 determines a parking position at which to park (step S4). Next, the recognizer 13 calculates a target parking position corresponding to the parking position determined by the determiner 12 (step S5), and transmits information on the target parking position to the parking control ECU 3 (step S6).

The parking control ECU 3 receives the information on the target parking position from the image processing ECU 1 (step S11). Next, based on the received information on the target parking position and the output of the clearance sonar sensor, the parking control ECU 3 infers a target parking position (step S12). The parking control ECU 3 may instead infer, based on the received information on the target parking position, a target parking position corresponding to the amount of movement of the reference vehicle. Then, the parking control ECU 3 transmits information on the inferred target parking position to the image processing ECU 1 (step S13).

The determiner 12 receives the information on the target parking position inferred by the parking control ECU 3 (step S7). The recognizer 13 recognizes, instead of the already calculated target parking position (step S5), the target parking position inferred by the parking control ECU 3 as a new target parking position. Next, the image processing ECU 1 converts the world coordinate system back to the coordinate system of the camera images (step S8). Then, based on the target parking position newly recognized by the recognizer 13, the display controller 14 generates a display image having an indicator indicating the target parking position overlaid on the taken image output from the image acquirer 10, and shows the target parking position on the display screen of the display device 6 (step S9).

The image processing ECU 1 constantly checks for a terminating event during the flow of operation shown in FIG. 3 so that, when a terminating event occurs, the image processing ECU 1 immediately terminates the flow of operation shown in FIG. 3. Examples of terminating events include, for example, the distance from the coordinates of the target parking position to the origin in the world coordinate system having become equal to or less than a predetermined value which approximately equals zero, and the traveling speed of the reference vehicle having become higher than a predetermined speed.

4. Calculating a Target Parking Position

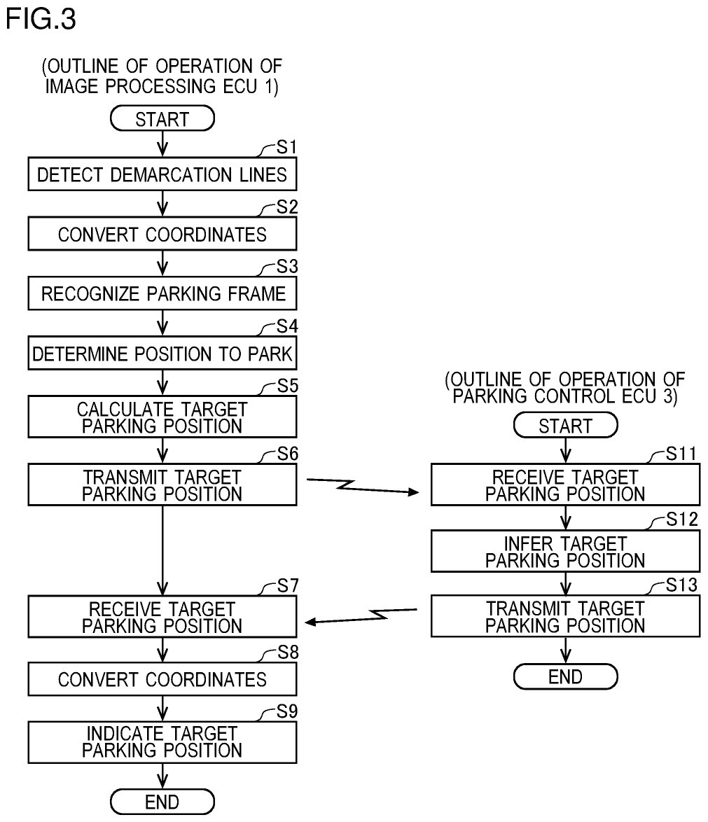

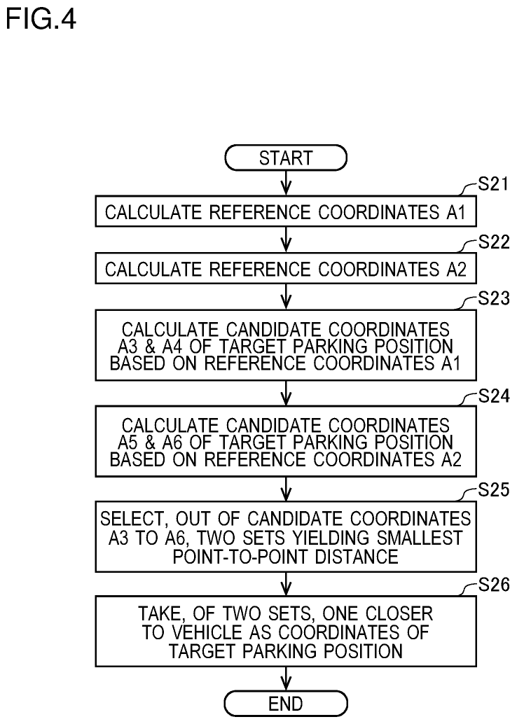

Next, how the image processing ECU 1 calculates a target parking position will be described. FIG. 4 is a flow chart showing the algorithm for calculating a target parking position. FIG. 5 is a top view showing a relationship between end point coordinates and candidate coordinates of a target parking position.

In calculating a target parking position, first, the image processing ECU 1 calculates first coordinates A1 apart from end point coordinates EP1 of one demarcation line in the direction opposite from the vehicle by the effective length L0 (the length calculated by subtracting the rear overhang from the vehicle's total length) (step S21). Next, the image processing ECU 1 calculates second coordinates A2 apart from end point coordinates EP2 of the other demarcation line in the direction opposite from the vehicle by the effective length L0 (step S22). The results of parking frame detection include information on the end point coordinates EP1 and EP2 of the demarcation lines.

Next, the image processing ECU 1 calculates third coordinates A3 apart from the first coordinates A1 in the direction perpendicular to the long-side direction of the one demarcation line toward the other demarcation line by half the distance W between the end point coordinates EP1 and the other demarcation line, and calculates fourth coordinates A4 apart from the first coordinates A1 in the direction perpendicular to the long-side direction of the one demarcation line away from the other demarcation line by half the distance W (step S23). Moreover, the image processing ECU 1 calculates fifth coordinates A5 apart from the second coordinates A2 in the direction perpendicular to the long-side direction of the other demarcation line toward the one demarcation line by half the distance W, and calculates sixth coordinates A6 apart from the second coordinates A2 in the direction perpendicular to the long-side direction of the other demarcation line away from the one demarcation line by half the distance W (step S24).

Out of the third to sixth coordinates A3 to A6, the image processing ECU 1 selects two sets of coordinates that yield the smallest point-to-point distance (step S25), and takes, out of the two sets of coordinates selected, the one closer to the vehicle (the one with the shorter distance to the origin) as the coordinates of the target parking position (step S26), thereby ending the algorithm for calculating the coordinates of a target parking position.

Through the flow of operation shown in FIG. 4, the coordinates of a target parking position can be set at the position that is inward, by the effective length L0, of the vehicle-side ends of two demarcation lines (that is, the entrance of a parking bay) and that is located at the middle between the two demarcation lines.

5. Specific Examples of Correction

Next, some specific examples of the correction performed by the recognizer 13 will be described. It should be noted that, as the parking sequence proceeds from FIG. 2A to FIG. 2B to FIG. 2C to FIG. 2D, any demarcation line or parking frame once recognized is tracked through coordinate management, and the correction performed by the recognizer 13 is performed for each demarcation line and parking frame. Of the first to fifth examples of correction described below, more than one may be performed in combination.

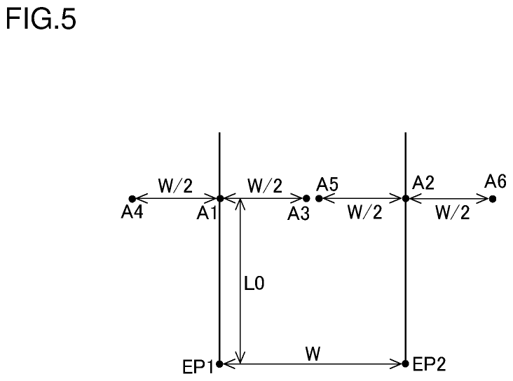

First Example of Correction: For example, the recognizer 13 can correct the recognition of the taken image of the rear camera 21 based on the shapes of demarcation lines recognized from the taken images of the left and right side cameras 22 and 23. Demarcation lines can have, for example, an “I” shape as shown in FIG. 6A, a “U” shape as shown in FIG. 6B, or a square-open-at-one side shape as shown in FIG. 6C.

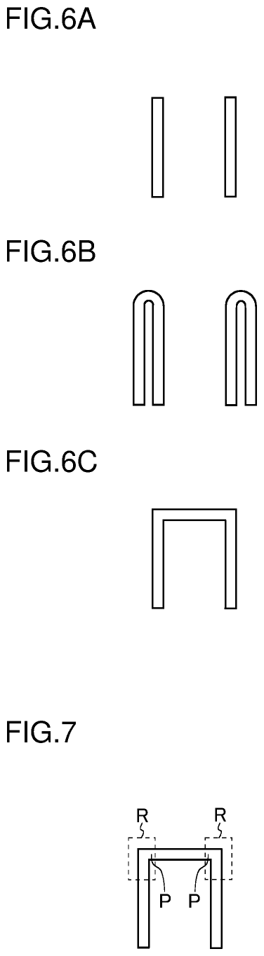

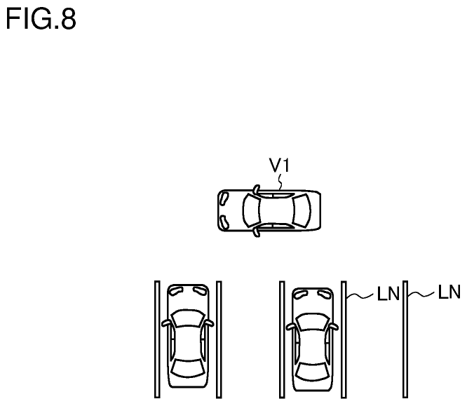

If demarcation lines have a square-open-at-one side shape as shown in FIG. 6C, then, during period C, the “region around end points of demarcation lines recognized last time or before” is the region R in FIG. 7. Here, unless the recognizer 13 properly recognizes the shape of the demarcation lines to be a square-open-at-one side shape as shown in FIG. 6C, the edges of jutting parts P at ends of the demarcation lines inside the region R may cause the recognizer 13 to erroneously recognize the direction of the demarcation lines.

To avoid that, when the shape of a demarcation line recognized from the taken images of the left and right side cameras 22 and 23 does not match the shape of the demarcation line recognized from the taken image of the rear camera 21, the recognizer 13 chooses the shape of the demarcation line recognized from the taken images of the left and right side cameras 22 and 23, and performs, based on the chosen shape of the demarcation line, recognition (with respect to other than the shape of the demarcation line) of the taken image of the rear camera 21. This improves the accuracy with which the recognizer 13 recognizes the direction of the demarcation line, and helps suppress deviation of the parking frame corresponding to the parking bay in which to park, and of the target parking position, from an appropriate position. That is, it is possible to cope with a case where, as a result of the rear camera 21 recognizing the shape of a demarcation line from an oblique direction and in addition from a remote position, the position of an edge of the recognized demarcation line is detected with a deviation. A deviation in the position of an edge of a demarcation line causes the demarcation line to be detected being more inclined than it actually is. Thus, in a case where the position of an edge of a demarcation line recognized by the rear camera 21 deviates by a predetermined amount or more from the position of the edge of the demarcation line recognized by the left or right side camera 22 or 23, it is preferable to use the position detected by the left or right side camera 22 or 23.

Second Example of Correction: For example, the recognizer 13 can correct the recognition of the taken image of the rear camera 21 based on the color of a demarcation line recognized from the taken images of the left and right side cameras 22 and 23.

Basically, the searcher 11 and the recognizer 13 perform image processing after converting the taken image acquired by the image acquirer 10 into a gray-scale image. However, since a demarcation line drawn in the form of a yellow line on a concrete pavement has low contrast to the concrete on a gray-scale image, the searcher 11 and the recognizer 13 detect a yellow region in the taken image and detect the edges of the yellow region to recognize a yellow demarcation line. Even then, if the yellow demarcation line on the taken image has low resolution, the recognizer 13 may erroneously recognize, or fail to recognize, the yellow demarcation line.

To avoid that, if the color of a demarcation line recognized from the taken images of the left and right side cameras 22 and 23 deviates by a predetermined level or more from the color of the demarcation line recognized from the taken image of the rear camera 21, the recognizer 13 chooses the color of the demarcation line recognized from the taken images of the left and right side cameras 22 and 23, and performs, based on the chosen color of the demarcation line, recognition (with respect to other than the color of demarcation line) of the taken image of the rear camera 21. This improves the accuracy with which the recognizer 13 recognizes the color of a demarcation line, and helps suppress deviation of the parking frame corresponding to the parking bay in which to park, and of the target parking position, from an appropriate position.

Third Example of Correction: For example, the recognizer 13 can correct the recognition of the taken image of the rear camera 21 based on the direction of a demarcation line recognized from the taken images of the left and right side cameras 22 and 23.

The recognizer 13 may erroneously recognize the direction of a demarcation line in a manner as mentioned above in connection with the first example of correction.

To avoid that, if the direction of a demarcation line recognized from the taken images of the left and right side cameras 22 and 23 deviates by a predetermined level or more from the direction of the demarcation line recognized from the taken image of the rear camera 21, the recognizer 13 chooses the direction of the demarcation line recognized from the taken images of the left and right side cameras 22 and 23, and performs, based on the chosen direction of the demarcation line, recognition (with respect to other than the direction of the demarcation line) of the taken image of the rear camera 21. This improves the accuracy with which the recognizer 13 recognizes the direction of a demarcation line, and helps suppress deviation of the parking frame corresponding to the parking bay in which to park, and of the target parking position, from an appropriate position.

Fourth Example of Correction: For example, the rear camera 21 can correct the recognition of the taken image of the rear camera 21 based on the width of a demarcation line recognized from the taken images of the left and right side cameras 22 and 23.

Demarcation lines generally have a width (line width) of about 10 cm to 15 cm; in contrast, gratings generally have a width of about 30 cm to 50 cm. It is thus preferable to check the width of a demarcation line recognized from the taken image against a threshold value so that, if it is equal to or larger than the threshold value, the demarcation line will no longer be dealt with as one recognized from the taken image.

Even then, if the demarcation line on the taken image has low resolution, the recognizer 13 may erroneously perform the check against the threshold value.

To avoid that, if the width of a demarcation line recognized from the taken images of the left and right side cameras 22 and 23 deviates by a predetermined level or more from the width of the demarcation line recognized from the taken image of the rear camera 21, the recognizer 13 chooses the width of the demarcation line recognized from the taken images of the left and right side cameras 22 and 23, and performs, based on the chosen width of the demarcation line, recognition (the above-mentioned check of the width of the demarcation line against the threshold value) of the taken image of the rear camera 21. This improves the accuracy with which the recognizer 13 recognizes a demarcation line, and helps suppress deviation of the parking frame corresponding to the parking bay in which to park, and of the target parking position, from an appropriate position.

Fifth Example of Correction: For example, the recognizer 13 can correct the recognition of the taken image of the rear camera 21 based on the width (bay width; see the distance W in FIG. 5) of a parking frame recognized from the taken images of the left and right side cameras 22 and 23.

Parking frames generally have a width of about 2 m. It is thus preferable to check the width of a parking frame recognized from the taken image against a threshold value so that, if it is equal to or larger than the threshold value, the parking frame will no longer be dealt with as one recognized from the taken image.

Even then, if the demarcation line on the taken image has low resolution, the recognizer 13 may erroneously perform the check against the threshold value.

To avoid that, if the width of a parking frame recognized from the taken images of the left and right side cameras 22 and 23 deviates by a predetermined level or more from the width of the parking frame recognized from the taken image of the rear camera 21, the recognizer 13 chooses the width of the parking frame recognized from the taken images of the left and right side cameras 22 and 23, and performs, based on the chosen width of the parking frame, recognition (the above-mentioned check of the width of the parking frame against the threshold value) of the taken image of the rear camera 21. This helps suppress erroneous recognition of a parking frame by the recognizer 13, and helps suppress deviation of the parking frame corresponding to the parking bay in which to park, and of the target parking position, from an appropriate position.

6. Notes

The various technical features disclosed herein may be implemented in any other manner than as in the embodiment described above, and allow for many modifications without departing from the spirit of the present invention. That is, the embodiment described above should be understood to be in every aspect illustrative and not restrictive. The technical scope of the present invention is defined not by the description of the embodiment given above but by the appended claims, and should be understood to encompass any modifications made in the sense and scope equivalent to those of the claims.

For example, although the embodiment described above deals with a configuration where a single ECU (image processing ECU) is provided with an image recognition device and a display control device, an image recognition device and a display control device may instead be implemented in separate ECUs.

The embodiment described above deals with a parking assist system that assumes backward parking. Considering, however, that many parking facilities encourage forward parking out of consideration to the neighborhood and other reasons, it is also possible to configure a parking assist system that assumes forward traveling instead of backward traveling in the above-described embodiment and that uses the taken image of the front camera 20 instead of the taken image of the rear camera 21 in the above-described embodiment.

The embodiment described above deals with a configuration where the image taking section 2 is provided with four cameras 20 to 23. The number of cameras, however, is not limited to four; any number, two or more, of cameras may be provided. For one example, in a case where each camera has a comparatively wide angle of view, the image taking section 2 may be provided with three, i.e., fewer than four, cameras. For another example, in a case where each camera has a comparatively narrow angle of view, the image taking section 2 may be provided with five, i.e., more than four, cameras. Also in these modified example, as in the embodiment described above, the searcher 11 can search for demarcation lines indicating parking bays based on a first taken image obtained by a first camera, the recognizer 13 can recognize the demarcation lines based on a second taken image obtained by a second camera, and based on the result of recognition, obtained in the searcher 11, of the first taken image, the recognition of the demarcation lines in the second taken image can be corrected.

What is claimed is:

1. An image recognition device comprising:
a searcher configured to search for a demarcation line indicating a parking bay based on a first taken image obtained by a first camera taking an image around a vehicle;
a determiner configured to determine a parking position at which to park based on a result of searching by the searcher; and
a recognizer configured to recognize, after determination by the determiner, the demarcation line based on a second taken image obtained by a second camera taking an image around the vehicle,
wherein the recognizer corrects recognition of the demarcation line in the second taken image based on a result of recognition, obtained in the searcher, of the first taken image.

2. The image recognition device according to claim 1, wherein
the recognizer is configured to recognize, after inferring that at least part of the vehicle has entered the parking bay, the demarcation line based on the first taken image.

3. The image recognition device according to claim 1, wherein
the first camera is a camera that takes an image sideways of the vehicle, and the second camera is a camera that takes an image rearward or frontward of the vehicle.

4. The image recognition device according to claim 1, wherein
the recognizer corrects the recognition of the demarcation line in the second taken image based on a shape of the demarcation line recognized from the first taken image.

5. The image recognition device according to claim 4, wherein
if the shape of the demarcation line recognized from the first taken image deviates by a predetermined amount or more from the shape of the demarcation line recognized from the second taken image, the recognizer chooses the shape of the demarcation line recognized from the first taken image, and corrects, based on the chosen shape of the demarcation line, the recognition of the demarcation line in the second taken image.

6. The image recognition device according to claim 1, wherein
the recognizer corrects the recognition of the demarcation line in the second taken image based on a color of the demarcation line recognized from the first taken image.

7. The image recognition device according to claim 1, wherein
the recognizer corrects the recognition of the demarcation line in the second taken image based on a direction of the demarcation line recognized from the first taken image.

8. The image recognition device according to claim 1, wherein
the recognizer corrects the recognition of the demarcation line in the second taken image based on a width of the demarcation line recognized from the first taken image.

9. The image recognition device according to claim 1, wherein
the recognizer corrects the recognition of the demarcation line in the second taken image based on a width of the parking bay recognized from the first taken image.

10. An image recognition method comprising:
a searching step of searching for a demarcation line indicating a parking bay based on a first taken image obtained by a first camera taking an image around a vehicle;
a determining step of determining a parking position at which to park based on a result of searching in the searching step; and
a recognizing step of recognizing, after determination in the determining step, the demarcation line based on a second taken image obtained by a second camera taking an image around the vehicle,
wherein, in the recognizing step, recognition of the demarcation line in the second taken image is corrected based on a result of recognition, obtained in the searching step, of the first taken image.

11. A parking assist system comprising:
the image recognition device according to claim 1; and
a parking control device configured to calculate an amount of control for the vehicle based on a result of recognition by the image recognition device.
